(19) United States
(12) Patent Application Publication
(10) Pub. No.: US 2017/0132361 A1
(43) Pub. Date: May 11, 2017

(54) SEQUENCE ASSEMBLY METHOD

(71) Applicant: Pacific Biosciences of California, Inc., Menlo Park, CA (US)

(72) Inventors: Shoudan Liang, Palo Alto, CA (US); Chen-Shan Chin, San Leandro, CA (US)

(21) Appl. No.: 15/333,841

(22) Filed: Oct. 25, 2016

Related U.S. Application Data
(60) Provisional application No. 62/247,378, filed on Oct. 28, 2015.

(51) Int. Cl. G06F 19/22

(52) U.S. Cl. CPC G06F 19/22

(57) ABSTRACT

Computer implemented methods for improving the assembly of sequence data are provided. in preferred embodiments, these methods increase the efficiency of assembly of sequence datasets from complex samples, such as genomes having repetitive regions.

### CROSS-REFERENCE TO RELATED APPLICATION

This application claims the benefit of priority to U.S. Provisional Patent Application 62/247378, filed Oct. 28, 2015, entitled “Sequence Assembly Method”, which is hereby incorporated by reference herein in its entirety.

### BACKGROUND OF THE INVENTION

Analysis of the subtleties of the voluminous amounts of genetic information will continue to have profound effects on the personalization of medicine. For example, this advanced genetic knowledge of patients has and will continue to have broad impact on the ability to diagnose diseases, identify predispositions to diseases or other genetically impacted disorders, and identify reactivity to given drugs or other treatments, whether adverse or beneficial.

Before one can begin to interpret genetic data from patients, one must first obtain the genetic information from that patient. Technologies have been developed that allow for broad screening of large swaths of a patient's genetic code by identifying key signposts in that code and using this fragmented data as a general interpretation mechanism, e.g., using libraries of known genetic variations, such as SNPs or other polymorphisms, and correlating the profile of such variations against profiles that have a suspected association with a given disease or other phenotype.

Rather than rely upon disparate pieces of information from the genetic code, it would be of far more value to be able to rely upon the entire text of a patient's genetic code in making any interpretations from that code. In using an analogy of a novel, one gains a substantially deeper understanding of all the elements of the novel, e.g., plot, characters, setting etc., by reading the entire text, rather than by picking out individual words from disparate pages or chapters of the novel.

Technologies related to analysis of biological information have advanced rapidly over the past decade. In particular, with the improved ability to characterize genetic sequence information, identify protein structure, elucidate biological pathways, and manipulate any or all of these, has come the need for improved abilities to derive and process this information.

In the field of genetic analysis, for example, faster and faster methods of obtaining, nucleic acid sequence information have consequences in terms of requiring different and often times better methods and processes for processing the raw genetic information that is generated by these processes. This progress has been evidenced in the improvements applied to separations based Sanger sequencing, where improvements in throughput and read-length have come not only through multiplexing of multi-capillary systems, but also from improvements in base calling processes that are applied to the data derived from the capillary systems. With shifts in the underlying technology surrounding genetic analysis, also comes a necessity for a shift in the methods and processes for processing the information from these systems. The present invention provides solutions to these and other problems.

In a resequencing study, a researcher gains insight for a biological question by comparing how the sequence of a sample differs from a reference genome. The positions in the genome where the differences occur are typically not known, and may be detected by randomly sequencing small fragments of the sample and comparing them to the reference, a method known as shotgun resequencing. The locations of the randomly sequenced fragments are not known, so an initial step in resequencing is to align the reads to their homologous locations on the reference genome.

Since the sample genome has mutations and reads have errors, homology is typically defined as the most similar sequence in the reference to the read and formulated as the highest scoring local alignment. This may be simply found with Smith-Waterman alignment (Smith, et al. (1981) J. Mol. Biol. 147:194-197); however, this is computationally prohibitive, so heuristics are necessary. A successful heuristic is sensitive to genomic variation and sequencing error; as sequencing methods have changed methods for aligning reads have evolved in step. Initial resequencing projects, such as the International Hap Map Project (Nature 409:31-46 (2001)), used Sanger sequencing (Sanger, et al. (1977) Proc. Natl. Acad. Sci. 74:5463-5467). The instrument frequently used for Sanger sequencing, the ABI 3730, produces reads roughly 1000 bases long with an accuracy over 99.5% cite that are rapidly aligned using MEGABLAST [25], cross match [11], and/or BLAT [14]. Each of these methods employ a Seed-and-Extend heuristic search, where short, 8-11 base, exact matches (words) are found using a hash table of the genome, and a detailed alignment is performed around regions that contain a sufficiently high number of exact matches. With reads of several hundred bases that are highly accurate, this is sufficient for aligning reads from sample genomes within the 0-1% range of common human genetic variation.

The methods developed to align reads produced by Sanger sequencing do not perform well on reads produced by Second-Generation massively parallel sequencing platforms such as the Illumina HiSeq (San Diego, Calif., USA) and Life SOLiD (Foster City, Calif., USA). Both platforms read bases four orders of magnitude faster than the state of the art in Sanger sequencing; however the reads have lower accuracy, and shorter length: 100 bases in the Illumina HiSeq and 75 bases in SOLiD 4. These platforms use the technique of amplified and cycled (AC) sequencing where millions of short templates are amplified while kept spatially separate, and then sequenced in controlled cycles of base interrogating reactions and imaging (Margulies, et al. (2005) Nature 437:376-380; Bentley, et al. (2008) Nature 456:53-59).

The initial methods developed for aligning AC sequenced reads such as Eland (IIlumina), SOAP (Li, et al. (2009) Bioinformatics 25:1966-1967), and MAQ (Li, et al. (2008) Genome Research 18:1851-1858) were based on hashing methods but achieved much faster performance than MEGA-BLAST or BLAT by bounding the number of differences allowed in a match between a read and the genome. A major algorithmic breakthrough for aligning AC reads was developed in the Bowtie alignment program (Langmead, et al. (2009) Genome Biology 10:R25) by using the Burrows-Wheeler Transformation (BWT) with an Ferrangina-Manzini (FM) index (Ferragina, et al. (2000) In Proc. of the 41st IEEE Symposium on Foundations of Computer Science, pages 390-398) of a genome rather than hash tables to detect matches between a read and a genome. The BWT-FM index, described in detail below, supports O(Q) time queries for counting the number of times a query string is present in a target, where Q is the length of the query string. Reads that map to the genome without differences are found very quickly, and reads that have low error rates in the 50 end may have their prefix mapped to a very small number of candidate positions in the genome before scoring each alignment (Li, et al. (2008) Genome Research 18:1851-1858). As a result, the Bowtie method was one to two orders of magnitude faster than hash-based methods (Langmead, et al. (2009) Genome Biology 10:R25). Other mapping algorithms such as Maq and SOAP were revised to run queries using BWT-FM indices as well, with similar speedup (Li, et al. (2009) Bioinformatics 25:1754-1760; Li, et al. (2009) Bioinformatics 25:1966-1967). These methods have been robust in aligning data produced by recent updates of AC sequencing instruments, which have doubled the length of reads and increased throughput by nearly two orders of magnitude since the BWT-FM based methods were introduced.

Advances in isolation and imaging of single molecules have facilitated the development of methods for sequencing single molecules. The Pacific Biosciences® Single-Molecule Real-Time (SMRT®) sequencing platform produces reads by detecting fluourescently labeled nucleotides as a template sequence is replicated by DNA polymerase (Korlach, et al. (2008) Nucleosides, Nucleotides and Nucleic Acids 27:1072-1083; Eid, et al. (2009) Science 323:133-138; Levene, et al. (2003) Science 299: 682-686, the disclosures of which are incorporated herein by reference in their entireties for all purposes). The polymerase and template are bound to the bottom of a zero-mode waveguide (ZMW) that limits the detection volume to the zeptoliter scale allowing the signal from the incorporated nucleotides to be distinguished from the background signal of nucleotides in solution. An alternative method has been shown to detect bases that have been cleaved by endonuclease and pass through a protein nanopore by monitoring modulations of ionic current across the pore (Clarke, et al. (2009) Nature Nanoteclmology 4:265-270, incorporated herein by reference in its entirety for all purposes). Finally, a method has been recently demonstrated for identifying bases that have translocated through a nanopore fabricated in a graphene membrane (Garaj, et al. (2010) Nature 467:190-193). The mapping methods written for AC sequencing reads will likely not work well on SMS reads, and older alignment methods such as Blast will be too slow. Thus there is a need for the development of new mapping methods for single molecule sequencing reads.

### BRIEF SUMMARY OF THE INVENTION

The invention is generally directed to methods, systems, and compositions, and particularly computer-implemented processes for analyzing sequence data. In certain embodiments, the invention is particularly useful for analyzing biomolecular sequence data, e.g., amino acid or nucleic acid sequence data. Nucleic acid sequence data generated during sequencing reactions is particularly suitable for use with the invention, e.g., for ultimately identifying sequence information of a target nucleic acid sequence. Methods are provided for determining the optimal overlap criteria to use during sequence assembly. The invention is also directed to devices and systems that carry out these processes.

The invention and various specific aspects and embodiments will be understood with reference to the following drawings and detailed descriptions. In some of the drawings and detailed descriptions below, the present invention is described in terms of an important independent embodiment of a system operating on a logic processing device, such as a computer system. This should not be taken to limit the invention, which, using the teachings provided herein, can be applied to any number of logic processors working together, whether incorporated into a camera, a detector, other optical components, or other information enabled devices or logic components incorporated into laboratory or diagnostic equipment or in functional communication therewith. For purposes of clarity, this discussion refers to devices, methods, and concepts in terms of specific examples. However, the invention and aspects thereof may have applications to a variety of types of devices and systems. It is therefore intended that the invention not be limited except as provided in the attached claims.

Furthermore, it is well known in the art that logic systems and methods such as described herein can include a variety of different components and different functions in a modular fashion. Different embodiments of the invention can include different mixtures of elements and functions and may group various functions as parts of various elements. For purposes of clarity, the invention is described in terms of systems that include many different innovative components and innovative combinations of innovative components and known components. No inference should be taken to limit the invention to combinations containing all of the innovative components listed in any illustrative embodiment in this specification. The functional aspects of the invention that are implemented on a computer or other logic processing systems or circuits, as will be understood from the teachings herein, may be implemented or accomplished using any appropriate implementation environment or programming language, such as C, C++, Cobol, Pascal, Java, Java-script, HTML, XML, dHTML, assembly or machine code programming, RTL, etc. All references, publications, patents, and patent applications cited herein are hereby incorporated by reference in their entirety for all purposes.

Although specific embodiments are described herein, it is to be understood that the methods described herein may be used in combination with other methods, systems, and compositions related to nucleic acid sequence data analysis including, e.g., those described in U.S. Pat. No. 7,056,661; U.S. Patent Publication No. 2009002433; U.S. patent application Ser. No. 12/592,284, filed Nov. 20, 2009; Korlach, et al. (2008) Nucleosides, Nucleotides and Nucleic Acids 27:1072-1083; Lundquist, et al. (2008) Optics Letters 33(9):1026; Eid, et al. (2009) Science 323:131-138; and Levene, et al., Science 299 (5607):682-686 (2003), all of which are incorporated herein by reference in their entireties for all purposes.

Further, various embodiments and components of the present invention employ pulse, signal, and data analysis techniques that are familiar in a number of technical fields. For clarity of description, details of known techniques are not provided herein. These techniques are discussed in a number of available references works, such as: R. B. Ash. Real Analysis and Probability. Academic Press, New York, 1972; D. T. Bertsekas and J. N. Tsitsiklis. Introduction to Probability, 2002; K. L. Chung, Markov Chains with Stationary Transition Probabilities, 1967; W. B. Davenport and W. L Root. An introduction to the Theory of Random Signals and Noise. McGraw-Hill, New York, 1958; S. M. Kay, Fundamentals of Statistical Processing, Vols. 1-2, (Hardcover-1998); Monsoon H. Hayes, Statistical Digital Signal Processing and Modeling, 1996; Introduction to Statistical Signal Processing by R. M. Gray and L. D. Davisson; Modern Spectral Estimation: Theory and Application/Book and Disk (Prentice-Hall Signal Processing Series) by Steven M. Kay (Hardcover-January 1988); Modern Spectral Estimation: Theory and Application by Steven M. Kay (Paperback-March 1999); Spectral Analysis and Filter Theory in Applied Geophysics by Burkhard Buttkus (Hardcover-May 11, 2000); Spectral Analysis for Physical Applications by Donald B. Percival and Andrew T. Walden (Paperback-Jun. 25, 1993); Astronomical Image and Data Analysis (Astronomy and Astrophysics Library) by J.-L. Stark and F. Murtagh (Hardcover-Sep. 25, 2006); Spectral Techniques In Proteomics by Daniel S. Sem (Hardcover-Mar. 30, 2007); Exploration and Analysis of DNA Microarray and Protein Array Data (Wiley Series in Probability and Statistics) by Dhammika Amaratunga and Javier Cabrera (Hardcover-Oct. 21, 2003), all of which are incorporated herein by reference in their entireties for all purposes.

### BRIEF DESCRIPTION OF THE DRAWINGS

FIG. 1 provides a validation of the ideal overlap model for E. coil.

FIG. 2 shows the results of TAP applied to CHM1, a human haploid cell line.

FIG. 3 shows that the faster alignment should be balanced by the loss of coverage due to the exclusion of reads shorter than the minimum length cutoff.

### DETAILED DESCRIPTION OF THE INVENTION

### I. General

The methods presented herein are generally applicable to analysis of sequence information, and in particular the assembly of overlapping sequence data into a contig, which can be further analyzed to determine a consensus sequence. While many different type of sequence data can be analyzed using the methods and systems described herein, the invention is especially suitable for analysis of sequences of biomolecular sequences, such as nucleic acids and proteins. Methods for sequencing biomolecules have been known to those of skill in the art for many years, and more advanced techniques that increase throughput, readlength, and accuracy have been developed and commercially introduced. These advances have vastly increased the amounts of sequence data produced, as well as the need for improved sequence analysis techniques.

The methods described herein are applicable to many different types of sample sequences, e.g., DNA, RNA, protein, etc. In some embodiments, a dataset of sample sequences to be analyzed comprises nucleic acids from a target region within a genome, an entire chromosome, or in particularly preferred embodiments, a whole genome of an organism, e.g., human or other animal, plant, bacteria, archaean, fungus, virus, or a combination thereof, e.g., for metagenomic analysis. In certain embodiments, the methods herein increase the efficiency and/or decrease the time needed for whole genome assembly.

In certain aspects, the present invention provides methods that improve de novo assembly and consensus sequence determination of biomolecular (e.g., nucleic acid or polypeptide) sequence data. Typically, a first step in sequence analysis is determination of one or more sequence “reads,” or contiguous orders of the molecular units or “monomers” in the sequence. For example, a nucleic acid sequencing read comprises an order of nucleotides or bases in a polynucleotide, e.g., a template molecule and/or a polynucleotide strand complementary thereto. Exemplary methods for determination of sequence reads that can be analyzed by the methods provided herein include, e.g., Sanger sequencing, shotgun sequencing, pyrosequencing (454/Roche), SOLiD sequencing (Life Technologies), tSMS sequencing (Helicos), Illumina® sequencing, nanopore sequencing (Oxford Nanopore), and in certain preferred embodiments, single-molecule real-time (SMRT™) sequencing (Pacific Biosciences of California). These methods are well known to those of ordinary skill in the art, and each can produce sequence reads that can be aligned and assembled using methods described herein. In preferred embodiments, the sequence reads have a very long average read length, e.g., at least about 2, 3, 4, 5, 7, 10, 15, 20, 30, 40, or 50 kb.

For each type of sequencing technology, experimental data collected during one or more sequencing reactions must be analyzed to determine one or more sequence reads for a given template nucleic acid subjected to the sequencing reaction(s). For example, pyrosequencing relies on production of light by an enzymatic reaction following an incorporation of a nucleotide into a nascent strand that is complementary to a template nucleic acid; fluorescently-labeled oligonucleotides are detected during SOLiD sequencing, and fluorescently-labeled nucleotides are used in tSMS, Illumina®, and SMRT sequencing reactions. For example, in SMRT sequencing, a set of differentially labeled nucleotides, template nucleic acid, and a polymerase are present in a reaction mixture. As the polymerase processes the template nucleic acid a nascent strand is synthesized that is complementary to the template nucleic acid. The label on each nucleotide is typically and preferably linked to a portion of the nucleotide that is not incorporated into the nascent strand. The labeled nucleotides in the reaction mixture bind to the active site of the polymerase enzyme, and during the binding and subsequent incorporation of the constituent nucleoside monophosphate, the label is removed and diffuses away from the complex. For example, where the label is linked to the terminal phosphate group of the nucleotide, it is cleaved from the nucleotide by the enzymatic activity of the polymerase which cleaves the polyphosphate chain between the alpha and beta phosphates. Since detection of fluorescent signal is typically restricted to a small portion of the reaction mixture that includes the polymerase, e.g., within a zero-mode waveguide (ZMW), a series of fluorescence pulses are detectable and can be attributed to incorporation of nucleotides into the nascent strand with the particular emission detected being indicative of a specific type of nucleotide (e.g., A, G, T, or C). Further details of SMRT sequencing are provided in Korlach, et al. (2008) Nucleosides, Nucleotides and Nucleic Acids 27:1072-1083; Eid, et al. (2009) Science 323:133-138; and in U.S. Pat. Nos. 7,056,661, 7,315,019, and 6,917,726, all of which are incorporated herein by reference in their entireties for all purposes. By analyzing various characteristics of the “pulse trace,” which comprises the series of detected fluorescence pulses, the sequence of nucleotides incorporated can be determined and, by complementarity, the sequence of at least a portion of the template nucleic acid is derived therefrom. The identification of the type and order of nucleotides incorporated is typically performed using computer-implemented methods, e.g., such as those described in U.S. Patent Publication No. 2009/0024331 and U.S. Provisional Application No. 61/307,672, filed Feb. 24, 2010, the disclosures of which are incorporated herein by reference in their entireties for all purposes.

Different sequencing technologies have different inherent error profiles in the sequence reads they produce. Redundancy in the sequence data can be used to identify and correct errors in individual sequence reads. Various methods are used to produce sequence data having such redundancy. For example, the reactions can be repeated, e.g., by iteratively sequencing the same template, or by separately sequencing multiple copies of a given template. In doing so, multiple reads can be generated for one or more regions of the template nucleic acid, and preferably each read overlaps completely or partially with at least one other read in the data set produced by the redundant sequencing. Further, different regions of a template can be sequenced by using different primers to initiate sequencing in different regions of the template, and preferably the resulting sequence reads overlap to allow construction of a consensus sequence representative of the true sequence of the different regions of the template nucleic acid based upon sequence similarity between portions of different reads that overlap within those regions. Further information on strategies for generating overlapping sequence reads and redundant sequencing of nucleic acids is provided in U.S. Pat. No. 7,476,503; U.S. Patent Publication Nos. 20090298075, 20100081143, and 20100311061;and U.S. patent application Ser. No. 12/982,029, filed Dec. 30, 2010, the disclosures of which are incorporated herein by reference in their entireties for all purposes. The sequence reads for a given template sequence are assembled like a puzzle based upon sequence overlap between the reads, e.g., to form a “contig,” and the alignment of the reads relative to one another provides the position of each read relative to the other reads and, preferably, relative to the template nucleic acid. In general, longer and more accurate reads facilitate contig assembly, and in some embodiments a known “reference” sequence (e.g., from a public database or repository) can also be used during construction of the contig. A region that is covered by two or more individual sequence reads having overlapping segments corresponding at least to the region can then be subjected to a more accurate sequence determination that is generally impossible using a single sequence read. The overlapping portions of the sequence reads that correspond to the region are compared or otherwise analyzed with respect to one another. In this way, erroneously called bases can be identified and, optionally corrected, in individual reads during the assembly process, and this information used to determine a more accurate consensus sequence for the region. In other words, once the alignment between separate reads is determined, a best or most likely call can be determined for each position in the overlapping portions, assigned to that position in a consensus sequence, and used to determine the most likely call for that position in the original template molecule. Certain methods for consensus sequence determination that can be used with the alignment and assembly methods provided herein are provided in U.S. Patent Publication No, 2010/0169026, the disclosure of which is incorporated herein by reference in its entirety for all purposes.

Repetitive sequences can be a substantial fraction of complex genomes, which can cause the repeat-to-repeat alignments produced during genome assembly to dominate the overlap calculation, producing excess alignments that are not helpful for assembly and tend to confuse the assembler. In fact, examination of genomes from higher-complexity organisms, e.g., human, maize, and fungi, show that a large proportion of the alignment data consists of reads for a small number of very high copy-number loci with the alignments due to repeats exceeding the alignments of unique regions by from 100 to 1000 times on average. (It is thought that some of these high copy-number loci likely include one or more of chloroplast sequences, mitochondrial genomes, centromeric or telomeric regions, and/or viruses.) For example, when assembling the human genome using the default settings for the Daligner parameters, the alignment of repeats is about one thousand times that of unique regions. (For more information on the Daligner alignment software, see Myers, G. (2014) Algorithms Bioinform. 8701: 52-67, which is incorporated herein by reference in its entirety for all purposes.) Further complicating the alignment process, state-of-art assembly of long reads typically requires an all-against-all alignment. During genome assembly, the amortized computing hardware cost can run upward of $1000 per human genome assembly. As such, the alignment calculation is the most resource intensive step in the complex-genome assembly process.

Alignment of repeats is computationally expensive because the number of alignments, and thus the computational cost, is proportional to the square of the number of repeats. For example, a sequence that repeats 1000 times in a genome generates a million hits in pairwise alignments. Furthermore, these repeat-to-repeat alignments do not provide useful information. As such, the computational time spent aligning these repeat regions is a significant inefficiency for assembly processes. The computation can be sped up by up to one hundred fold or more if alignments of repeats can be avoided. Therefore a general method of estimating repeat alignments aimed at reducing them by choosing right alignment parameters is provided herein.

In certain aspects, the invention provides methods to monitor and to greatly reduce amount of calculations involving alignments of repetitive DNA sequence. This will speed up the most computationally intensive steps in genome assembly. It can be used to improve computational speed of any overlap-layout-consensus assembler, including the MHAP (MinHash Alignment Process) assembler and the PacBio® FALCON assembler, which are described in detail in Berlin, et al. (2015) Nature Biotechnology 33:623-630: U.S. Patent Publication No. 2015/0169823; and U.S. application Ser. No. 14/743,713, filed Jun. 18, 2015, all of which are incorporated herein by reference in their entireties for all purposes.

Although certain aspects of the methods herein focus on an alignment of reads produced by a PacBio® System sequencing instrument (Pacific Biosciences, Menlo Park, Calif.), the characteristics of sequences reads produced by the PacBio® instrument are likely to be common to other sequencing methods, especially those that produce long reads, such as those produced by nanopore sequencing methods.

### II. Algorithm Overview

Since most of the computation time during assembly is spent on aligning repetitive regions, and the alignment thereby produced are not very useful for genome assembly, a new method was developed to decrease the amount of time spent aligning repeats. The methods herein provide an additional step in the assembly process that occurs prior to assembly of the entire set of reads, and contrary to the conventional expectation that an additional step can be considered lessening the efficiency of a process, the addition of this step greatly increases the efficiency of assembly overall.

In preferred embodiments, the parameter to be optimized is the minimum length of the overlap required for an alignment. When this minimum exceeds the length of the repeat, the repeat will no longer be aligned, thus the overall computation is reduced. Further, the length of overlap is computed in seeding stage, which is only a small part of overall computation. For example, the ALU repeat region is 300 bp in length. Alignments requiring an overlap of greater than 300 bp will miss the ALU repeat, whereas alignments requiring only a 200 bp overlap will produce many alignments from the ALU repeat region. Requiring a minimum overlap is not without drawbacks. This optimization involves a trade-off between computation speed and fold-coverage of the targeted sample nucleic acid (e.g., genome) by sequence reads. Since the reads shorter than the minimum overlap length will not be aligned and are in effect removed from assembly, the effective coverage and the contiguity of final assembly may be reduced. The amount of reduction will depend on the distribution of read length, if the overlap parameter is too long, many reads that are shorter than the overlap requirement will not be included in the alignment If the overlap parameter is too short, much of the alignment will result from alignments within repetitive regions. As such, the optimal overlap parameter must balance these two alignment priorities.

In certain aspects, a tool called TAP (Tuning Assembly Parameters) is used to help select the optimal assembly parameters. Assembly parameters, such as minimum required overlap length, are optimized on a small fraction of the data set. In certain embodiments, about 0.25%, 0.5%, 0.75%, 1%, 2%, or 3% of the data is used in this “pre-alignment” step. With proper scaling, computation on a small set predicts computation time on the entire dataset. Other parameters that can benefit from optimization (“tuning”) are (1)—k, the length of seeding k-mers, and (2)—h, the minimum length of kmer overlap.

In certain aspects, the method involves using a model of the expected alignment in the absence of repeats and comparing the model with empirical alignment data from an alignment run on a small portion of the nucleic acid sample to be assembled. The model to provide the “ideal overlap” assumes that (i) the sample dataset contains no repeats, (ii) the reads in the alignment are drawn randomly from the dataset, and (iii) the aligner is perfect (100% sensitive and specific). The expected alignment for a non-repetitive genome can be derived assuming that reads are drawn randomly from the dataset, e.g., genome. The expression can be written in closed form as is an integral over the distribution of read length. The expected pairwise overlap is:

$$\frac{{N}_{ovlp} ( L )}{{XN}_{nucl}} = {( \frac{{N}_{read}}{{N}_{nucl}} {\int }_{L}^{∞} ( x - L ) f ( x ) d x )}^{2}$$

Here, L is the minimum overlap length; Nₒᵥₗₚ(L) is total number of pairwise overlaps; X is the per-site coverage (X=N_{nucl}/G); and N_{nucl} is the total number of nucleotides in the reads; and G is the size of the genome. Note that Nₒᵥₗₚ(L), X, and N_{nucl} should be computed on the same partial data set. When L=0, the right-hand side is equal to one. For L>0, the right-hand side will be less than one. The right-hand side can be interpreted as square of the fold of reduction in effective coverage due to the requirement of increased overlap length. Note that Nₒᵥₗₚ(L) can be measured from a fraction of data. If the factor XN_{nucl} for the same data used is used, then this can be directly comparable to the right-hand side. In summary, the ideal overlap is what the pairwise overlap should be as a function of minimum overlap length if the genome has no repeats. It is computed from the distribution of read lengths for the dataset. The actual overlap is computed on a partial data set (to ease the computation). Since the reads are distributed randomly among files, the partial data should be a good approximation to the entire data set. It is scaled to be directly comparable to the ideal overlap.

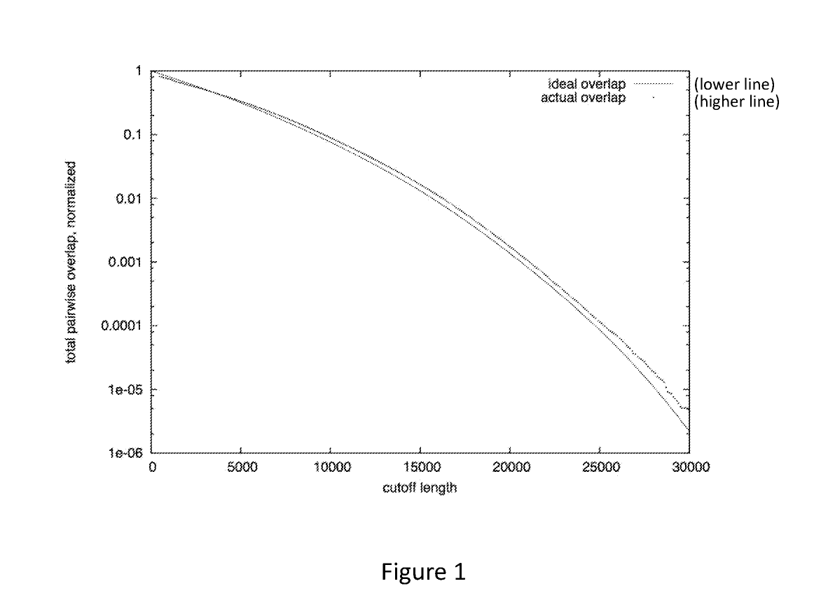

A validation of the ideal overlap model for E. coli is shown in FIG. 1, which compares ideal alignment based on read length (lower line) to the actual alignment (higher line). Since E. coli genome is mostly non-repetitive, the assumptions made in deriving the ideal alignment hold true. The two curves are compared and found to be essentially identical without needing to adjust any parameters. The reason for the actual overlap to be above the idealized overlap at a large cutoff value could be due to rRNA repeats. The actual alignment flattens out at a small cutoff, most likely due to loss in sensitivity at the lower read lengths.

Assembly statistics from the analysis of the B73 Maize genome at various coverage levels is provided in the table below (Table 1). The length cutoff was computed from the analysis of ideal overlap using Lander-Waterman theory.

TABLE 1

| Coverage used | N50 | # of contigs | length cutoff |
|---|---|---|---|
| 70x | 1,726,472 | 3,580 | 12,000 |
| 50x | 491,204 | 9,302 | 8,000 |
| 40x | 355,656 | 11,783 | 6,500 |
| 30x | 177,133 | 19,807 | 4,000 |

Of course, these overlap length cutoffs are merely exemplary for this dataset, and the optimal length cutoff is determined independently for different datasets. For example, depending on the sample and the fold-coverage in the dataset, the optimal length cutoff may be at least 1, 3, 5, 7, 10, 12, 15, or 20 kb, or even higher (e.g., 20-50 kb) where the average read lengths are long enough to get sufficient coverage.

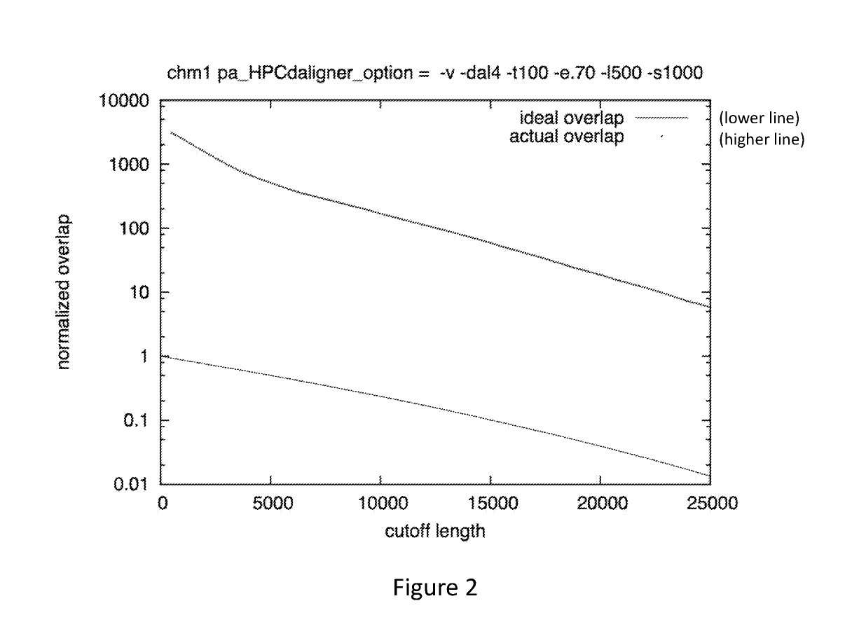

TAP can be used in different ways. In certain embodiments, the amount of repetitive sequences and other high copy-number components (e.g., chloroplasts, mitochondrion, etc.) can be estimated using the comparison since the actual overlap is proportional to the Daligner computation time. The actual curve should be above the ideal overlap curve due to the repeats in the dataset. The distance between these two curves is a measure of the extra computation required because of the repetitive sequences. For a large genome, it is usually 100-to 1000-fold more computation for a large genome. See, e.g., FIG. 2. which shows the results of TAP applied to CHM1, a human haploid cell line. The graph demonstrates that the read-to-read alignments resulting from repeats are about 1000-fold higher than would be expected for a 3 Gb non-repetitive genome. The methods provided herein can reduce the alignments resulting from repeats significantly, e.g., at least 2-, 5-, 10-, 20-, 50-, or 100-fold or more.

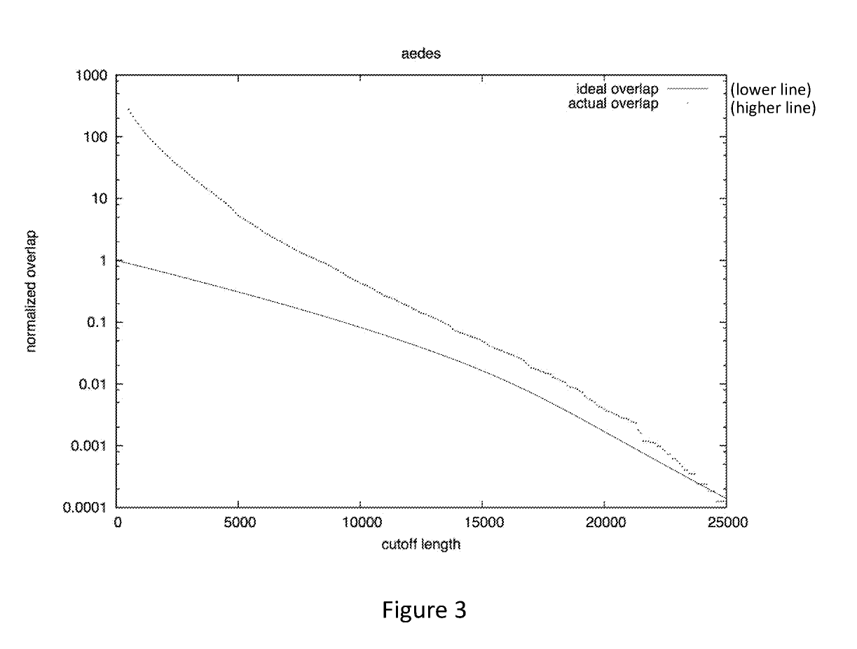

In other embodiments, the actual overlap curve can be used to estimate the computation savings at a given cutoff or set of cutoffs, e.g., by comparing the overlap at one or more desired length cutoffs and the zero cutoff See, e.g., FIG. 3, which shows that the speedup should be balanced by the loss of coverage due to the exclusion of reads shorter than the minimum length cutoff. When increasing minimum overlap length, computational saving needs to be balanced with the reduction in effective coverage which can be detrimental to assembly. A reasonable rule of thumb is to use Lander-Waterman theory. For example, in order for the mean contig length to be one Mb, the coverage should be 10X for the human genome according to the Lander-Waterman criterion. From the ideal overlap curve, a practitioner of the instant invention can read off the folds of reduction by comparing the y-axis at the desired cutoff to the zero cutoff and take the square root. The actual Daligner overlaps for yellow fever mosquito decrease rapidly below 5 kb, which suggest that 5 kb is a good choice for minimum required overlap. At cutoff length of 5 kb, the reduction in ideal overlap (black curve) is about a quarter of the overlap at zero cutoff. Therefore the effective reduction of coverage at cutoff 5 kb is about ½.

In certain aspects, the invention provides methods for alignment and assembly of nucleic acid sequencing reads. The methods herein may be used in combination with other alignment and assembly methods known to those of ordinary skill in the art. For example, these methods may comprise one or more alignment algorithms that align each read using a reference sequence. In some embodiments in which a reference sequence is known for the region containing the target sequence, the reference sequence can he used to produce an alignment using a variant of the center-star algorithm. Alternatively, the sequence alignment may comprise one or more alignment algorithms that align each read relative to every other read without using a reference sequence (“de novo assembly routines”), e.g., PHRAP, CAP, ClustalW, T-Coffee, AMOS make-consensus, or other dynamic programming MSAs. Additional alignment and assembly methods are described in “Assembly and Alignment Algorithms for Next-Gen Sequence Data” (December 2008/January 2009) Genome Technology; Boisvert et al., (2010) J. Comput. Biol. 17(11):1519-33; Butler et al. (2008) Genome Res. 18:810-820; Chevreux, et al. (1999) ISMB meeting, Heidelberg, Germany; DiGuistini, et al. (2009) Genome Biology 10:R94; Jeong, et al. (2008) Genomics & Informatics 6(2):87-90; Li et al., Genome Res. published online, Aug. 19, 2008; Li et al. (2008) Bioinformatics 24:713-714; Ning et al. (2001) Genome Res. 11:1725-1729; Shendure et al. (2008) Nature Biotechnology 26:1135-1145; Sundquist et al. (2007) PLoS One 2:e484; Warren et al. (2007) Bioinformatics 23:500-501; and Zerbino et al. (2008) Genome Res. 18:821-829, the disclosures of which are incorporated herein by reference in their entireties for all purposes. Further, computer software read assemblers are now available, e.g., The TIGR Assembler (Sutton et al. (1995) Genome Science and Techology 1:9-19); GAP (Bonfield et al (1995) Nucleic Acids Res. 23:4992-4999); CAP2 (Huang et al. (1996) Genomics 33:21-31); the Genome Construction Manager (Laurence et al. (1994) Genomics 23:192-201); Bio Image Sequence Assembly Manager; SeqMan (Swindell et al. (1997) Methods Mol. Biol, 70:75-89); and LEADS and GenCarta (Compugen Ltd., Israel), which may also be used with the methods described herein.

In some embodiments, the invention can be used with methods for aligning and assembling sequence reads based at least in part on a known reference sequence, which is sometimes termed “resequencing” or “mapping.” In such embodiments, the sequence reads can be mapped to the reference sequence, and loci that have basecalls that differ from the reference sequence can be further analyzed to determine if a given locus was erroneously called in the sequence read, or if it represents a true variation (e.g., a mutation, SNP variant, etc.) that distinguishes the nucleotide sequence of the reference sequence from that of the template nucleic acids that were sequenced to generate the sequence reads. Such variations may encompass multiple adjacent positions in the reference and/or the sequencing reads, e.g., as in the case of insertions, deletions, inversions, or translocations. As such, a sequence is assembled based upon the alignment of the reference sequence and the sequence reads that are similar but not necessarily identical to at least a portion of the reference sequence.

In related aspects, the invention can be used with methods for aligning and assembling sequence reads that do not use a known reference sequence, which is sometimes termed “de novo sequencing.” In such applications, the sequence reads are analyzed to identify overlap regions, which are aligned to each other to generate a contig, which can be subjected to consensus sequence determination, e.g., to form a new, previously unknown sequence, such as when an organism's genome is sequenced for the first time. In general, de novo assemblies are orders of magnitude slower and more memory intensive than resequencing assemblies, mostly due to the need to analyze or compare every read with every other read, e.g., in a pair-wise fashion. Typically, in such applications the sequence reads themselves are used as “reference” in the alignment algorithms.

In certain aspects, the invention can be used with methods for hybrid assembly of nucleic acid sequencing reads, in particular assembly of long (e.g., those generated by Pacific Biosciences® SMRT® sequencing (“PacBio reads”) or by nanopore sequencing) and short (e.g., those generated by Illumina®) nucleic acid sequencing reads. Hybrid assembly is a method by which reads from different sequencing methodologies are aligned with one another, and such alignments are useful in many contexts. While more and longer sequence reads facilitate identification of sequence overlaps, they may have higher error rates than reads from short-read technologies. Conversely, short sequence reads are faster to align, but are more difficult to align when the template from which they were generated comprises repeats (identical or near-identical) or large rearrangements, such as inversions or translocations, that are longer than the length of the short reads. Typically, longer reads from a first platform are used to form a “baseline” to which other types of reads, e.g., from short-read platforms, are added. For example, since different researchers may use different sequencing platforms, the methods herein allow sequencing data from the different platforms to be combined to provide overall higher quality data, e.g. due to higher redundancy or compensation of one or more weaknesses of one with the strengths of the other. Further, a hybrid assembly can be used to select regions of high quality reads from one platform (“A”) based on the “higher quality” sequence generated by the other platform (“B”).

VI. Computer Implementation

In certain aspects, the methods provided herein are computer-implemented methods, wherein at least one or more steps of the method are carried out by a computer program. In some embodiments, the methods provided herein are implemented in a computer program stored on computer-readable media, such as the hard drive of a standard computer. For example, a computer program for determining at least one consensus sequence from replicate sequence reads can include one or more of the following: code for providing or receiving the sequence reads, code for identifying regions of sequence overlap between the sequence reads, code for aligning the sequence reads to generate a layout, contig, or scaffold, code for consensus sequence determination, code for converting or displaying the assembly on a computer monitor, code for applying various algorithms described herein, and a computer-readable storage medium comprising the codes.

In some embodiments, a system (e.g., a data processing system) that determines at least one assembly from a set of sequences includes a processor, a computer-readable medium operatively coupled to the processor for storing memory, wherein the memory has instructions for execution by the processor, the instructions including one or more of the following: instructions for receiving input of sequence reads, instructions for overlap detection between the sequence reads, instructions that align the sequence reads to generate a layout, contig, or scaffold, instructions that apply a consensus sequence algorithm to generate at least one consensus sequence (e.g., a “best” consensus sequence, and optionally one or more additional consensus sequences), instructions that compute/store information related to various steps of the method, and instructions that record the results of the method.

In certain embodiments, various steps of the method utilize information and/or programs and generate results that are stored on computer-readable media (e.g., hard drive, auxiliary memory, external memory, server, database, portable memory device (CD-R, DVD, ZIP disk, flash memory cards, etc.), and the like. For example, information used for and results generated by the methods that can be stored on computer-readable media include but are not limited to input sequence read information, set of pair-wise overlaps, newly generated consensus sequences, quality information, technology information, and homologous or reference sequence information.

In some aspects, the invention includes an article of manufacture for determining at least one assembly and/or consensus sequence from sequence reads that includes a machine-readable medium containing one or more programs which when executed implement the steps of the invention as described herein.

As will be understood to practitioners in the art from the teachings provided herein, the invention can be implemented in hardware and/or software. In some embodiments of the invention, different aspects of the invention can be implemented in either client-side logic or server-side logic. As will be understood in the art, the invention or components thereof may be embodied in a fixed media program component containing logic instructions and/or data that when loaded into an appropriately configured computing device cause that device to perform according to the invention. As will be understood in the art, a fixed media containing logic instructions may be delivered to a viewer on a fixed media for physically loading into a viewer's computer or a fixed media containing logic instructions may reside on a remote server that a viewer accesses through a communication medium in order to download a program component.

One type of an information appliance (or digital device) that may be understood as a logical apparatus that can read information (e.g., instructions and/or data) and use that information to direct server or client logic, as understood in the art, to embody certain aspects of the invention is a computer system that includes a CPU for performing calculations, a display for displaying an interface, a keyboard, and a pointing device, and further comprises a main memory storing various programs and a storage device that can store the input sequence, statistics for ideal overlap computation, statistics for actual overlap computation, statistics for normalized overlap computation, and minimum overlap length(s). The device is not limited to a personal computer, but can be any information appliance for interacting with a remote data application, and could include such devices as a digitally enabled television, cell phone, personal digital assistant, etc. Information residing in the main memory and the auxiliary memory may be used to program such a system and may represent a disk-type optical or magnetic media, magnetic tape, solid state dynamic or static memory, etc. In specific embodiments, the invention may be embodied in whole or in part as software recorded on this fixed media. The various programs stored on the main memory can include a program to perform computation of ideal and actual overlap statistics, a program to compare the ideal and actual overlap statistics, a program to compute an optimal overlap length, and the like. The lines connecting the CPU, main memory, and auxiliary memory may represent any type of communication connection. For example, the auxiliary memory may reside within the device or may be connected to the device via, e.g., a network port or external drive. The auxiliary memory may reside on any type of memory storage device (e.g., a server or media such as a CD or floppy drive), and may optionally comprise multiple auxiliary memory devices, e.g., for separate storage of input sequences, results of alignments and overlap computations, results of overlap comparisons, results of optimal overlap length determinations, and/or other information.

The progress of the various operations in the method of the present invention can he displayed on the display. After completing this processing, the various inputs sequences, statistics and graphical representations thereof, comparisons of different minimum overlaps lengths and how they impact computation time, and other inputs and outputs from the processing can be also displayed on a monitor or other device having a visual display, saved to an additional storage device (e.g., ZIP disk, CD-R, DVD, floppy disk, flash memory card, etc.), or displayed and/or saved in hard copy (e.g., on paper). The results of the processing may be stored or displayed in whole or in part, as determined by the practitioner.

It is to be understood that the above description is intended to be illustrative and not restrictive. It readily should be apparent to one skilled in the art that various modifications may be made to the different embodiments of the invention disclosed in this application without departing from the scope and spirit of the invention. The scope of the invention should, therefore, be determined not with reference to the above description, but should instead be determined with reference to the appended claims, along with the full scope of equivalents to which such claims are entitled. Throughout the disclosure various references, patents, patent applications, and publications are cited. Unless otherwise indicated, each is hereby incorporated by reference in its entirety for all purposes. All publications mentioned herein are cited for the purpose of describing and disclosing reagents, methodologies and concepts that may be used in connection with the present invention. Nothing herein is to be construed as an admission that these references are prior art in relation to the inventions described herein.

What is claimed is:

1. A method of reducing alignment between repeat sequences in a nucleic acid sequence dataset, the method comprising:
a. performing an alignment on a small portion of the dataset;
b. determining metrics for the alignment of the small portion;
c. determining metrics for an ideal alignment assuming the data set has no repeat sequences;
d. comparing the metrics for the alignment of the small portion with the metrics for the ideal alignment to provide an overlap comparison;
e. computing an optimal overlap length cutoff using the overlap comparison; and
f. using the optimal overlap length cutoff in an assembly of the nucleic acid sequence dataset,
wherein the alignment between repeat sequences in the assembly is reduced compared to performance of the assembly in the absence of the optimal overlap length cutoff.

2. The method of claim 1, wherein the small portion is less than 5% of the dataset.

3. The method of claim 1, wherein the small portion is less than 3% of the dataset.

4. The method of claim 1, wherein the small portion is no more than 1% of the dataset.

5. The method of claim 1, wherein the optimal overlap length cutoff was computed using the Lander-Waterman theory.

6. The method of claim 1, wherein the optimal overlap length cutoff is between 1 and 50 kb.

7. The method of claim 1, wherein the optimal overlap length cutoff is between 5 and 20 kb.

8. The method of claim 1, wherein the optimal overlap length cutoff is at least 10-15 kb.

9. The method of claim 1, wherein the reduction in alignments between repeat sequences in the assembly is at least 2-, 5-, 10-, 50-, or 100-fold.
